(19) United States
(12) Patent Application Publication
(10) Pub. No.: US 2002/0076308 A1
(43) Pub. Date: Jun. 20, 2002

(54) Chip diffuser

(76) Inventors: Kenneth Fred Bailey, Apex, NC (US); Ira D. Bly, Ola, AR (US)

Correspondence Address: SUMMA & ALLAN, P.A., 11610 NORTH COMMUNITY HOUSE ROAD, SUITE 200, CHARLOTTE, NC, 28277, US

(21) Appl. No.: 10/075,857

(22) Filed: Feb. 14, 2002

Related U.S. Application Data
(60) Provisional application No. 60/269,091, filed on Feb. 15, 2001.

(51) Int. Cl. A01F 25/18

(52) U.S. Cl. 414/301; 414/687

(57) ABSTRACT

Disclosed is a chip diffuser that is useful in efficiently distributing wood chips and other particulate materials. The chip diffuser includes a novel spider helix rotor assembly that includes a spider hub that is rotatably mounted upon a central shaft stem, and at least two vane mounting rods that are attached to the spider hub. In addition, substantially planar vanes are attached to the vane mounting rods typically in a one-to-one relationship. The chip diffuser preferably functions using only the kinetic energy of the falling wood chips or other particulate materials contacting the chip diffuser.

### CROSS-REFERENCE TO RELATED PROVISIONAL APPLICATION

This application hereby claims the benefit of copending U.S. provisional application Ser. No. 60/269,091, filed Feb. 15, 2001, for a Chip Diffuser, the disclosure of which is incorporated by reference in its entirety.

### FIELD OF THE INVENTION

The present invention relates to the efficient distribution of particulate material. More particularly, the present invention relates to a novel device that promotes the efficient distribution and oriented packing of wood chips and other kinds of plate-like material.

### BACKGROUND OF THE INVENTION

In transporting goods, whether by land or sea, there are often weight limits that restrict how much of the goods may be loaded onto the vehicle or vessel. The transportation of low-density goods, however, does not implicate such maximum weight limits, and so it is desirable to increase packing density to facilitate cost-effective transportation. Simply stated, when maximum weights are immaterial, it is more efficient to transport product rather than air.

For example, wood chips, a low-density, particulate commodity having a density of about 400 kilograms per cubic meter, are routinely transported by vessel. When doing so, it is desirable to ensure that the vessel's cargo hold is completely filled with wood chips. To accomplish this, motorized equipment (e.g., bulldozers or blowers) may be employed to redistribute the wood chips within the cargo hold to eliminate large empty spaces. This, however, does not eliminate, or even measurably reduce, the void spaces between the wood chips, which tend to become randomly oriented. Even where the wood chips are so redistributed, the vessel may be capable of taking on additional weight. Accordingly, it is desirable to increase the compaction of the wood chips and thereby the overall chip density within a cargo space.

Various kinds of distribution devices are known in the prior art. Some of these devices purport to reduce void spaces between loose materials. In general, such distribution devices include either blades that are affixed to a shaft or a solid surface distributor assembly (e.g., a pyramidal or conical structure).

With respect to devices having blades that are affixed to a central shaft, some of the devices are specifically employed to increase the compaction of wood chips. See J. Newell Stephenson, Preparation & Treatment of Wood Pulp at pages 334-336; Vol. 1, 1950 (disclosing a wood chip distributor having four distributing bats that are rotated by an electric motor at a rate of between about 700 and 900 rpm). Similarly, U.S. Pat. No. 5,348,434 (Peeples) for a Cargo Loading System discloses a device including a V-shape configuration of blades disposed around a center shaft, thereby forming a kind of inverted conical framework. These devices are motor-driven, however, which greatly complicates their use. Moreover, Peeples' device appears to be flow-limited, such that as the chip feed-rate is increased through the device, chip compaction decreases. Consequently, to overcome this deficiency at high feedrates, a much larger device must be used. This, however, adversely affects distribution at low feed-rates.

With respect to devices having a solid surface distributor, U.S. Pat. No. 5,393,189 (Berquist) for a Spreader for Particulate Material discloses a grain spreader that includes a rotatably-mounted, pyramidal body having at least three triangular sidewalls. Similarly, U.S. Pat. No. 3,643,819 (Halcomb) for a Distributor for Silage or the Like discloses a device including a pyramidal-shaped body that is rotatably mounted under a discharge outlet by a support, and U.S. Pat. No. 1,691,683 (Townsend) for an Automatic Ensilage Distributor for Silos discloses a device including a rotatably-mounted conical distributor having spiral impeller blades and scattering blades.

These devices are unlikely to withstand the kind of impacts associated with distributing denser, harder materials, such as wood chips. In this regard, most kinds of ensilage (e.g., livestock feed such as chopped cornstalks or sorghum stalks) can be easily deformed by human hands. In contrast, it is almost impossible to manually deform a wood chip, which will fracture before deforming. Moreover, wood chips, because of their composition (e.g., fiber and lignin), are generally much more abrasive than ensilage.

It is also thought that wood chips and other larger-sized materials require a larger cross-sectional flow path at a given feed-rate as compared to smaller-sized materials. For example, 1000 tons per hour of wood chips will likely require a much larger delivery chute cross-section than will 1000 tons per hour of grain. As compared to wood chips, ensilage that is chopped into nominal one-inch lengths has a similar particle size and will likely require a near-identical, cross-sectional flow path at a given feed-rate.

Therefore, there is a need for a non-motorized chip diffuser that requires only the kinetic energy of falling wood chips to effect its rotation, can function over a wide-range of material feed-rates, and yet can withstand the wear-and-tear inherent with wood chip transfer operations.

### SUMMARY OF THE INVENTION

Accordingly, it is an object of the present invention to provide a chip diffuser that is capable of efficiently distributing particulate material, such as wood chips.

It is a further object of the present invention to provide a chip diffuser that is capable of increasing the packing density of particulate material without employing a motor to directly drive its rotation. This is significant because it is expected that including an electric motor will increase installation and operation costs by at least 30 to 50 percent.

It is a further object of the present invention to provide a chip diffuser that is capable of distributing at least about five tons of wood chips per minute, while providing improved compaction even at very low feed-rates (e.g., just one chip at a time passing through the device).

It is a further object of the present invention to provide an improved method of distributing and orienting particulate material—especially wood chips—in a cargo hold, such as within a barge or railroad car.

It is a further object of the present invention to provide an improved method of delivering and compacting wood chips within a batch digester to thereby increase pulp mill production.

It is a further object of the present invention to provide an improved method of distributing and orienting wood chips in storage facilities, such as a paper mill wood yard.

These objects are accomplished by the present chip diffuser, which includes a novel spider helix rotor assembly. The spider helix rotor assembly includes a spider hub that is rotatably mounted upon a central shaft stem, and at least two vane mounting rods that are attached to the spider hub. In addition, substantially planar vanes are attached to the vane mounting rods.

In practice, particulate material (e.g., wood chips) is fed onto the spider helix rotor assembly and attached vanes, typically through a feed chute. The forces applied to the vanes by the falling particulate material cause the rotor assembly to rotate, thereby outwardly redirecting the chips. Excess material—non-uniformly sized particles that would typically hang-up in the chute-work of other devices—that falls on the rotor assembly is shed around its periphery.

Advantageously, the chip diffuser is resistant to plugs. For example, the centrifugal force as the rotor assembly turns prevents tree residuals from accumulating on the vanes or vane mounting rods. Likewise, any strings or slivers that catch on supports or struts are removed as the rotor assembly turns.

The foregoing, as well as other objectives and advantages of the invention and the manner in which the same are accomplished, is further specified within the following detailed description and its accompanying drawings.

### BRIEF DESCRIPTION OF THE DRAWING

FIG. 1 is a perspective view of a chip diffuser embodiment according to the present invention, and illustrating the flow direction of the particulate material.

FIG. 2 is a top plan view of the spider helix rotor assembly and attached vanes, taken generally along line 2-2 in FIG. 1.

FIG. 3 is a side-elevation, fragmentary view showing the detail of the spider helix rotor assembly rotatably mounted on the center shaft.

FIG. 4 is a bottom plan view of the spider helix rotor assembly and attached vanes of FIG. 3.

FIG. 5 is a top plan view of the spider helix rotor assembly, also showing a vane in an exploded position.

FIG. 6 is a top plan view of the spider helix rotor assembly, showing an alternative embodiment of fixing vanes thereto.

FIG. 7 is a perspective view of another chip diffuser embodiment according to the present invention

FIG. 8 is a side-elevation, fragmentary view showing the vane geometry for the chip diffuser of FIG. 7.

FIG. 9 is a photograph of wood chips that have been stacked using the chip diffuser according to the present invention.

### DETAILED DESCRIPTION

The invention is a chip diffuser that is useful in efficiently distributing and orienting particulate material, especially wood chips and other plate-like material. Interestingly, the chip diffuser does not require a motor in addition to the falling particulate material to drive the spider helix rotor assembly. Even so, employing the chip diffuser to distribute wood chips yields a regular and consistent chip orientation, thereby increasing overall storage density by as much as 30 percent.

Although the chip diffuser preferably distributes at least five tons of wood chips per minute, it is capable of distributing between about zero (i.e., very low feedrates) and at least 15 tons of wood chips per minute while retaining the aforementioned compaction advantages. Larger chip diffusers can even distribute as much as 30 tons of wood chips per minute. In fact, a maximum feed-rate where densifying efficiency diminishes has not yet been observed. In contrast to high-volume, open-chute discharge operations, using the chip diffuser makes it possible to completely fill an open-top compartment, such as a barge, with virtually no spillage over containment bulkheads.

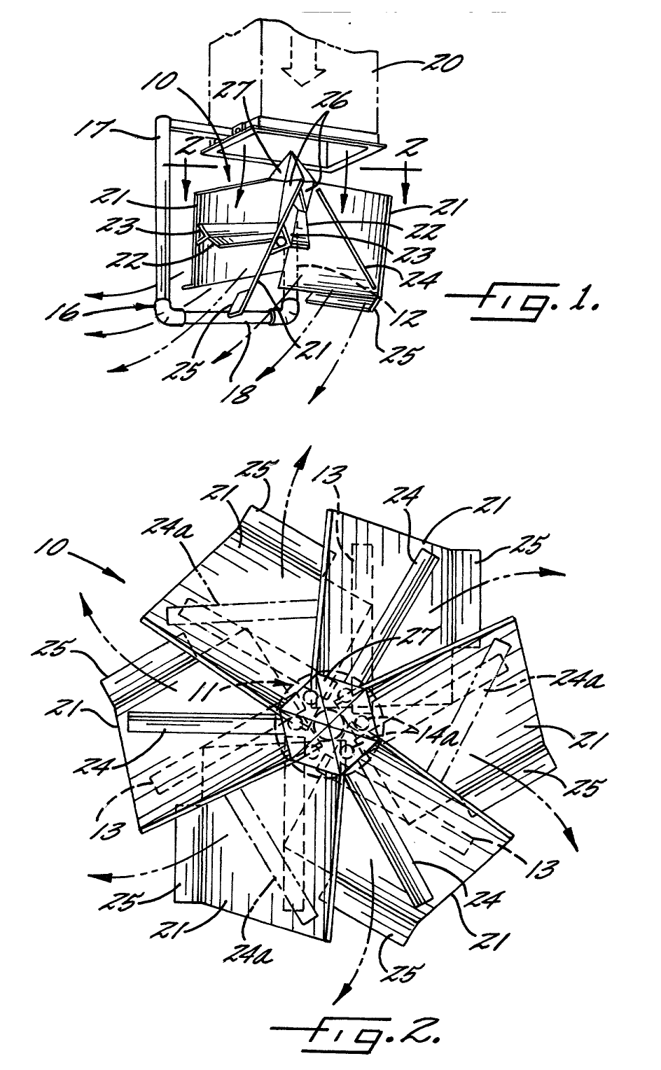

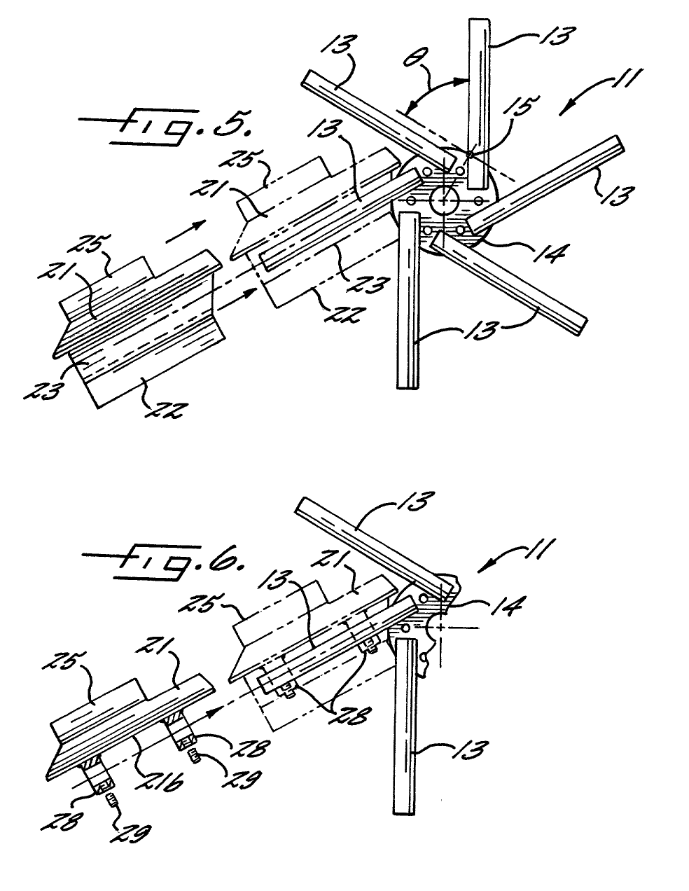

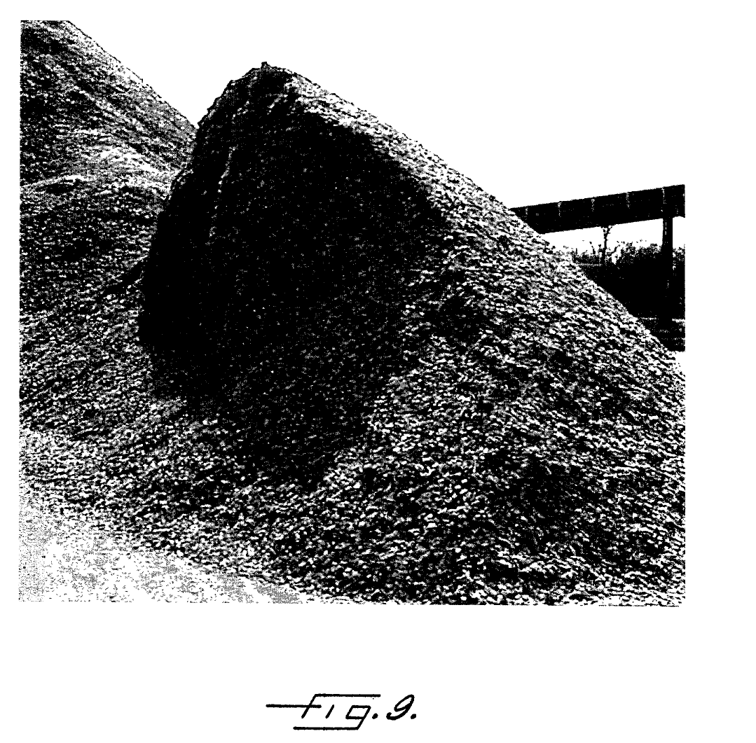

The present invention is herein described with particular reference to the accompanying drawings to enable the reader to practice the invention without undue experimentation. A more complete understanding of the present invention may be achieved by reference to FIGS. 1-8. In this regard, FIGS. 1-6 broadly illustrate the structural elements of chip diffuser 10 according to the present invention. FIGS. 7-8, which depict a preferred embodiment of the chip diffuser 10′, use reference numerals with a prime notation to refer to the corresponding elements illustrated in FIGS. 1-6. It will be readily apparent to those of ordinary skill in the art, however, that the description herein is directed not only to the basic structural elements of the chip diffuser 10 as depicted in FIGS. 1-6, but also to the modified structural elements of the chip diffuser 10′ shown in FIGS. 7-8. Moreover, those having ordinary skill in the art will recognize that many of the components and configurations can be modified without departing from the scope and spirit of the invention.

The chip diffuser 10 includes a rotor assembly 11 that is rotatably connected to a central shaft stem 12 (i.e., the central shaft stem 12 rotatably supports the rotor assembly 11). Preferably, the central shaft stem 12 includes an axle means 12a, which rotatably connects to the rotor assembly 11. Alternatively, the rotor assembly 11 includes the axle means 12a, which rotatably connects to the central shaft stem 12.

As will be understood by those familiar with the mechanical arts, the axle means 12a permits the rotor assembly 11 to rotate (i.e., axle means 12a includes bearings as shown in FIG. 3). For example, the central shaft stem 12 can be fabricated from one half of a trailer axle, wherein the rotor assembly 11 rather than a wheel is rotatably mounted to the half-trailer axle. The rotor assembly 11 may be rotatably mounted atop, beneath, or along the central shaft stem 12, provided that the central shaft stem 12 fixes the chip diffuser's 10 axis of rotation.

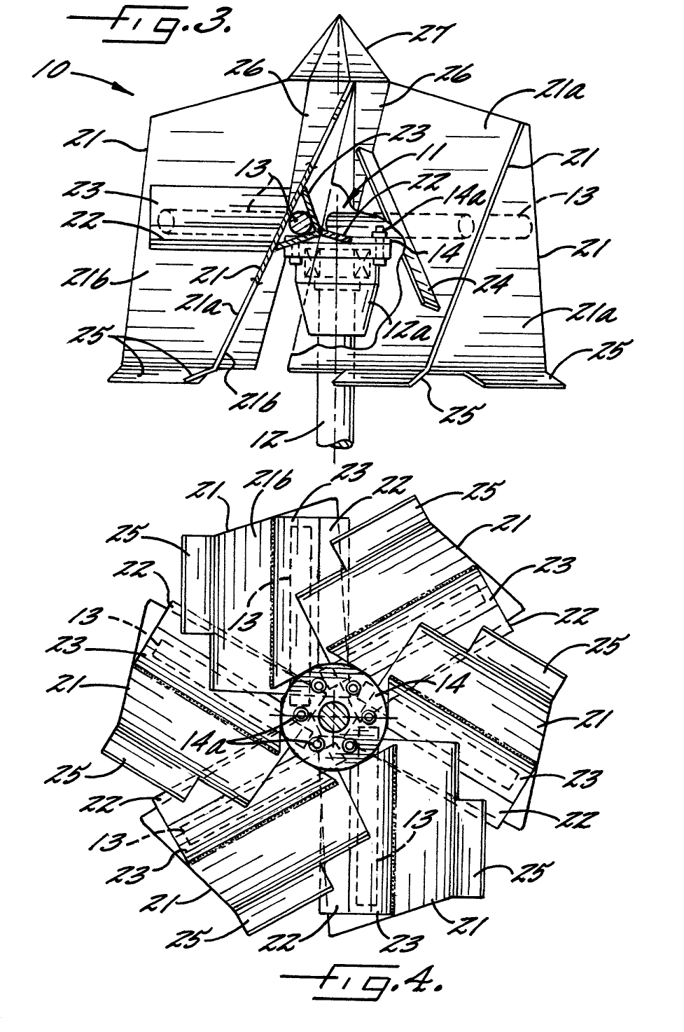

As noted, the rotor assembly 11 preferably has a spider helix arrangement. More specifically, as used herein, a spider helix describes an arrangement wherein at least two vane mounting rods 13 are non-radially—preferably near-tangentially—connected to a spider hub 14 in a modified hub-and-spoke arrangement. Typically, the spider hub 14 is simply a substantially circular flange defining an annular space. It is the spider hub 14 of the rotor assembly 11 that is rotatably connected to the central shaft stem 12, preferably by welds or an array of bolts 14a connected to the axle means 12a. FIGS. 2 and 4-6 show vane mounting rods 13 that are uniformly and near-tangentially attached to a spider hub 14.

Preferably, the spider helix rotor assembly 11 includes between about four and eight vane mounting rods 13 that are substantially uniformly spaced around the spider hub 14. Most preferably, the spider helix rotor assembly 11 includes six vane mounting rods 13 that are uniformly spaced around the spider hub 14 (i.e., 60° apart). The spider helix rotor assembly 11 is preferably substantially planar.

It has been observed that using a spider helix arrangement, rather than radial-spoke pattern, results in a much larger deposit area. This advantageously reduces the need to move the chip diffuser 10 around a compartment (e.g., a railroad car) during filling operations. Moreover, it is believed that the helical orientation better accommodates temporary flow surges as compared to a radial-spoke arrangement, which tends to bog down when subjected to such flow surges.

The spider helix rotor assembly 11 may be either leading or lagging. A leading or lagging spider helix is determined by whether the vane mounting rods 13 are oriented toward the direction of rotation or away from the direction of rotation, respectively, during operation. Preferably, the spider helix is in a leading arrangement such that its vane mounting rods 13 are non-radially oriented between about 50° (i.e., more leading) and 80° (i.e., less leading) from the tangents intersecting the respective contact points 15 between (i.e., defined by) the vane mounting rods 13 and a circular spider hub 14. See FIGS. 2, 4, and 5. In this regard and as used herein, a contact point 15 is simply the point where a vane mounting rod 13 extends away from the perimeter of the spider hub 14. See FIG. 5 (showing the angle θ at a contact point 15).

It will be recognized by those of ordinary skill in the art that, for a spider helix rotor assembly 11 of a given size, increasing non-radial offset increases the non-radial orientation of the spider helix rotor assembly 11. In this regard and as used herein, non-radial offset is the perpendicular distance from the center of the circular spider hub 14 to lines defined by the vane mounting rods 13 as extended past the center of the circular spider hub 14.

A corollary to this relationship between offset and orientation is that differently-sized spider helix rotor assemblies having the same degree of non-radial orientation will have different perpendicular offsets (as measured from the respective centers of the circular spider hubs 14 to the vane mounting rods 13, as extended). By way of example, larger chip diffusers 10 designed for loading ships can distribute about 2,000 tons per hour and typically have perpendicular non-radial offsets of about five inches, chip diffusers 10 designed for loading barges can distribute over 1,000 tons per hour and typically have perpendicular non-radial offsets of about 2.5 inches, and smaller chip diffusers 10 designed for loading railroad cars can distribute up to 600 tons per hour and typically have perpendicular non-radial offsets of between about 1.5 and 2 inches.

To further illustrate this concept, a 90° orientation would describe a radial design, as the vane mounting rods 13 would be aligned toward the chip diffuser's 10 axis at the center of the spider hub 14. In contrast, the spider helix rotor assembly 11 according to the present invention has its vane mounting rods 13 aligned away from the chip diffuser's 10 axis. The top plan view of FIG. 2 shows the spider helix rotor assembly 11 in a leading arrangement, as the rotation of the chip diffuser 10 would be counterclockwise as viewed from this perspective.

It has been observed that a leading spider helix arrangement creates a broader spray, which may be suitable for 30-foot wide barges, whereas a lagging spider helix arrangement creates a narrower spray, which may be suitable for 11-foot wide railroad cars and pulp mill batch digesters.

The invention further includes support means 16 to support the chip diffuser 10 during operation. In practicing the present invention, any means sufficient to secure the chip diffuser 10 as it rotates may be employed. It will be understood such support means 16 must be secured to a non-rotating component of the chip diffuser 10, such as the central shaft stem 12. Accordingly, the chip diffuser 10 is typically supported beneath its central shaft stem 12, as this reduces interference with the flow of particulate material, onto the chip diffuser 10. This is especially important when distributing wood chips, which include tree residuals such as cambium strings and slivers.

Preferably, the chip diffuser 10 is supported from beneath by at least one J-shaped support 16, and more preferably between one and four such supports. Each J-shaped support 16 comprises a relatively longer first support arm 17 and a relatively shorter second support arm—the aforementioned central shaft stem 12—that are connected by a strut 18 (i.e., the central shaft stem 12 is a component of each J-shaped support). In preferred embodiments, the first support arm 17 and the central shaft stem 12 are substantially vertical, and the connecting strut 18 is substantially horizontal.

It will be understood by those of ordinary skill in the art that a single J-shaped support 16 has only one vertical obstruction, and so is preferred if it is capable of adequately supporting the chip diffuser 10. See FIG. 1. More than one support 16 may be necessary, however, if the chip diffuser 10 requires additional stability. For example, it has been determined that up to four J-shaped supports 16 may be necessary to secure the chip diffuser 10 where the chip diffuser 10 is non-vertically oriented, such as under a non-vertical feed chute 20.

In another embodiment, the chip diffuser 10 can be held from above by one or more supports. This is desirable, for example, in employing the chip diffuser 10 in conjunction with a pulp mill digester. Preferably, the chip diffuser 10 is supported from the top by a single arm that is angled about 30-45° from the direction of chip flow, as this facilitates shedding of any passing slivers or wood-strips. Other support means 16 will be recognized by those of ordinary skill in the art.

During distribution operations, a feed chute 20 is typically positioned directly over the chip diffuser's 10 rotor assembly 11. Although the chip diffuser 10 is preferably secured to the feed chute 20, it need not be. The feed chute 20 can have any cross-sectional shape provided it functions as an effective conduit for particulate material. That said, it has been observed that, as compared with round-bottomed chutes 20, flat-bottomed chutes 20 seem to improve performance of the chip diffuser 10. In addition, feed-rates to the chip diffuser 10 can be regulated by including a flow adjustment means within the feed chute 20.

Preferably, the feed chute 20 is positioned to facilitate gravity feeding of particulate material to the rotor assembly 11 and attached vanes 21. Accordingly, the feed chute 20 is usually vertically oriented. The feed chute 20, however, may be oriented slightly off vertical (e.g., 15-20°) provided that a flow of particulate material can be adequately maintained. In this regard, feed chutes 20 have been successfully installed as much as 35° from vertical while maintaining full distribution. Such versatility facilitates installation of the chip diffuser 10 in congested locations where a vertical feed chute 20 is impracticable. Note, however, that if the angle of the feed chute 20 from vertical exceeds 35°, the distribution efficacy of the chip diffuser 10 is diminished. For example, a ten percent relative loss in compaction has been observed with respect to a feed chute 20 that is oriented 55° from vertical when discharging onto a vertically-oriented chip diffuser 10.

Where the feed chute 20 is non-vertical, the rotor assembly 11 can be mounted vertically, mounted such that the central shaft stem 12 is parallel to the feed chute 20, or mounted somewhere in between. For example, where the feed chute 20 is 20° from vertical, centering the chip diffuser 10 in the material flow path 100 from vertical works quite satisfactorily. When the feed chute 20 is non-vertical and the rotor assembly 11 is vertical, the feed chute 20 may be fitted with an elbow (not shown) at the feed chute's 20 outlet to direct the flow of wood chips vertically downward, just before the flow of chips strikes the rotor assembly 11 and attached vanes 21.

As noted, the chip diffuser 10 most preferably is connected to the feed chute 20 by at least one J-shaped support 16. This simplifies the positioning of the chip diffuser 10 within a cargo space, such as in a barge or railroad car. It will be recognized by those skilled in the art that the chip diffuser 10 may be operated without a feed chute 20, provided a continuous stream of particulate material can be delivered onto the chip diffuser 10.

The material flow does not necessarily have to be centered on the chip diffuser 10, so long as essentially all of the particulate material passes through the chip diffuser 10. It has been observed that concentrating material flow toward the outside of the chip diffuser 10 tends to increase rotational speed, whereas concentrating material flow onto the center of the chip diffuser 10 tends to decrease rotational speed. Note, however, that slower rotation does not appear to reduce the chip diffuser's 10 efficacy, and may be beneficial in some instances.

Substantially planar vanes 21 are attached to the vane mounting rods 13, preferably in a one-to-one relationship. In this regard, it will be understood by those of ordinary skill in the art that a chip diffuser 10 that has one or more vane mounting rods 13 either without a corresponding vane 21 or with more than one corresponding vane 21 is within the scope of the invention. The vanes 21 have a top surface 21a, which receives falling wood chips, and a bottom surface 21b (i.e., the backside surface), opposite the top surface 21a. The vanes 21 are oriented at an angled pitch (i.e., offset from the chip diffuser's 10 axis defined by the central shaft stem 12). The pitch of the vanes 21 is typically between about 10° and 40°, preferably between about 20° and 30°, and most preferably between about 22° and 25°, from the axis defined by the central shaft stem 12. In other words, when the chip diffuser 10 is vertically oriented, the vanes 21 are oriented at a pitch of between about 10° and 40° from vertical.

In an embodiment of the chip diffuser 10, the substantially planar vanes 21 are substantially rectangular. As used herein, the phrase “substantially rectangular” is meant to succinctly describe simple geometric shapes approximating a rectangle. For example, in one such embodiment, the substantially rectangular vanes 21 are trapezoidal (i.e., narrower toward the bottom of the chip diffuser 10). This trapezoidal vane 21 embodiment helps to control incidental scattering of material when loading smaller enclosures, such as railroad cars or batch digesters. A purely rectangular vane 21 shape seems to work more effectively when loading a larger area, such as a ship's cargo hold.

Other vane 21 shapes are within the scope of this invention, provided that there is sufficient overlap of the vanes 21. See FIG. 2. In other words, particulate material falling toward the chip diffuser 10 in a direction parallel to its fixed axis should not simply fall through the chip diffuser 10 without contacting a vane 21. In particular, while substantially planar vanes 21 are preferred, non-planar vanes 21 possessing curvature (i.e., vanes that appear similar to propeller blades) are within the scope of the invention.

In a typical embodiment, the vanes 21 are about two feet long and are mounted on the vane mounting rods 13 such that slightly more of the vanes 21 are positioned below vane mounting rods 13 than above the vane mounting rods 13 (e.g., ten inches above and 14 inches below, which would be appropriate for loading a barge having a 30-foot wide loading area).

In alternative embodiments, chip diffusers 10 having substantially planar, 16-inch vanes 21 can successfully densify chips at feed-rates exceeding 400 tons/hour. Such smaller vanes 21 are especially useful when loading batch digesters or railroad cars, which have about an 11-foor wide loading area. Moreover, it is within the scope of the invention to employ collapsible vanes 21 or a collapsible spider helix rotor assembly 11 to facilitate access to confined spaces, such as within a batch digester.

It will be understood by those skilled in mechanical arts that a larger diameter rotor is capable of providing a larger distribution area as larger rotors can accommodate larger feed-rates. At similar feed-rates, however, chip diffusers 10 of different sizes will have comparable distribution areas. For example, at a wood chip feed-rate of ten tons per minute, a 44-inch diameter device and a 60-inch diameter device will generate similar distribution areas. Increasing the wood chip feed-rate to 25 tons per minute through the 60-inch device, however, will at least double the distribution area.

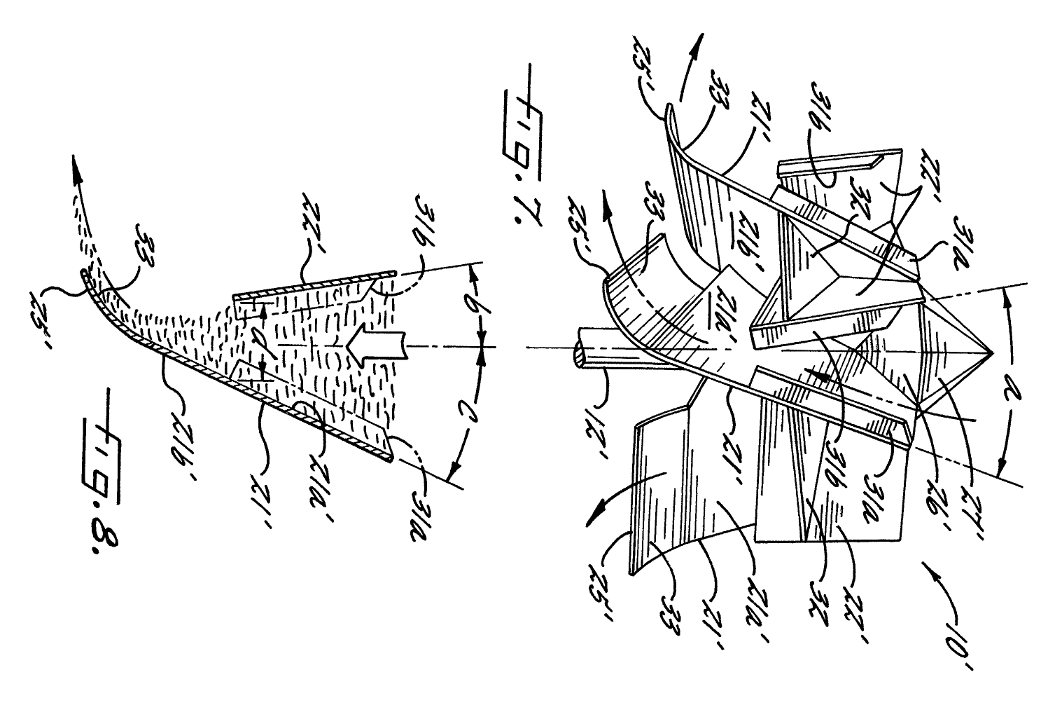

As shown in FIG. 5, as well as in FIG. 3, the vanes 21 can be mounted (e.g., welded) onto the vane mounting rods 13 via angle brackets 23. Alternatively, the vanes 21 can be removably mounted to the vane mounting rods 13 as shown in the partial exploded view of FIG. 6. In this regard, spaced locking collars 28 are fixed (e.g., welded) to the backside of the vane 21. Threaded locking screws 29 may be used in conjunction with the locking collars 28 to maintain the vanes 21 in their angular position on the vane mounting rods 13.

Preferably, the chip diffuser 10 includes a governing means to limit its rotational speed during operation. Otherwise, a stream of particulate material can generate rotational speed that exceeds the target of between about 50 and 200 RPMs. In one embodiment, the vane mounting rods 13 perform this function inherently. Controlling the rotational speed may also be achieved by varying the non-radial offset of the spider helix or adjusting material flow pattern onto the chip diffuser 10.

In preferred embodiments, however, at least one adjustable governor bar 22 is attached to the backside of each vane 21, usually to the bottom surface 21b of each vane 21. The governor bars 22 effectively control the maximum rotational speed of the rotor assembly 11 and thus the breadth of the diffusion pattern.

Falling particulate material (e.g., wood chips) that strikes the surface of the governor bar 22 slows the rotor assembly 11. In a preferred embodiment, one governor bar 22 is connected at a right angle to the bottom surface 21b of each vane 21, above the vane mounting rod 13. In another preferred embodiment shown in FIGS. 1 and 3, the governor bars 22 are connected to the angle brackets 23, which, as noted previously, help secure the vanes 21 to the vane mounting rods 13.

Accordingly, a governor bar 22 forms a kind of shelf on the bottom surface 21b of a vane 21. The width of the governor bar 22 (i.e., as shown in FIGS. 1 and 3, the perpendicular distance the governor bar 22 extends away from the vane 21) can be varied as is necessary to limit the maximum rotational speed of the rotor assembly 11. In this regard and as will be understood by those skilled in the art, more exposed surface area on governor bar 22 further limits maximum rotational speed. Preferably, the governor bars 22 have sufficient surface area to maintain the rotor assembly 11 rotation to less than 200 RPMs.

In another preferred embodiment shown in FIGS. 7-8, each governor bar 22′ is affixed on the backside of its corresponding vane 21′ (i.e., a first vane) to more or less face the next vane 21′ (i.e., a second vane). As compared with the governor bars 22 shown in FIGS. 1 and 3, the governor bars 22′ depicted in FIGS. 7-8 are not only larger (i.e., more plate-like), but also more downwardly angled. This configuration not only helps to regulate the rotational speed of the rotor assembly 11, but also forms troughs through which the falling particulate material must pass. A trough-forming geometry has been observed to funnel particulate matter to the top surface 21a of the vanes 21′. In this regard, governor bars 22′ are preferably positioned to focus particulate material toward the top surface 21a of the vanes 21′ rather than directly to the toe bar 25′. The spatial relationship between a governor bar 22′ and its neighboring vane 21′ is illustrated in FIG. 8

Referring specifically to FIGS. 7-8, the chip diffuser 10′ has an axis defined its central shaft stem 12′. As noted previously, the pitch of the vanes 21′ from this axis is typically between about 10° and 40°, preferably between about 20° and 30°, and most preferably between about 22° and 25°. As shown in FIG. 8, the pitch c of the vanes 21′ is about 25° and the pitch b of the governor bars 22′ is about 10°. Accordingly, the particulate material passes downwardly through the chip diffuser 10′ at an inclusive angle a of about 35°, as shown in FIG. 7, and outwardly through a trough outlet d formed by the governor bar 22′ and the vane 21′, as shown in FIG. 8. The width of this opening d is preferably about six inches as depicted in FIG. 8.

The governor bars 22 are typically positioned toward the upper middle portions on the backside of the vanes 21, but generally not at the uppermost edge. Preferably, the governor bars 22 are mounted onto the upper portions of the vane mounting rods 13. See FIG. 1 (showing governor bars 22 attached to angle brackets 23 on the bottom surface 21b of the vanes 21, adjacent to the vane mounting rods 13).

Where the governor bars 22 are positioned on the bottom surface 21b of the vanes 21, the governor bars 22 are shielded from chip flow at low feed-rates. As chip feed-rate increases, thereby increasing rotational speed, more and more chips contact the backside-mounted governor bars 22. Chips contacting the governor bars 22 retard the spinning of the rotor assembly 11. As rotation slows, fewer chips contact the governor bars 22. In this way, kinematic equilibrium (i.e., governed rotational speed) is quickly achieved.

During chip diffuser operations, it has been observed that wood chips that contact the vanes 21 and the governor bars 22 sometimes deflect sideways. To further improve densification, the chip diffuser 10′ can include means to downwardly redirect such deflected chips toward the vanes 21′. As shown in FIGS. 7 and 8, collector bars 31 may be affixed, typically at about right angles, to the top surface 21a′ of the vanes 21′, to the top surface of the governor bars 22′, or to both. In this regard, the top surface of a governor bar 22′ is that surface that comes in contact with falling particulate material. The collector bars 31 are generally positioned toward the outer edges of the vanes 21′ and governor bars 22′.

The width of the collector bars 31 is typically between about two and five inches, although it will be appreciated by those of ordinary skill in the art that this will depend on the size of the chip diffuser 10. The length of a (vane) collector bar 31a is preferably about half the length of its corresponding vane 21′. The length of a (governor bar) collector bar 31b is preferably slightly shorter than the length of its corresponding governor bar 22′. It has been observed that positioning the (governor bar) collector bar 31b down about two inches from the top of the governor bar 22′ eliminates the accumulation of strings and slivers.

The configuration of the collector bars 31 can be adapted as is necessary for the particular chip diffuser configuration. For example, in one embodiment the collector bars 31 are affixed to the bottom surface 21b of each vane 21 and extend downwardly along the outer vane 21 edges. In a related embodiment, the collector bars 31 are affixed to the bottom surface 21b of each vane 21 and extend downwardly and outwardly (e.g., about at a 45° angle) from a position near top of the vanes 21 to a position perhaps several inches outside the vanes 21. In these embodiments, which are appropriate where narrow governor bars 22 are connected at a right angle to the bottom surface 21b of each vane 21 (as shown in FIGS. 1 and 3), the collector bars 31 downwardly direct those chips that contact the governor bars 22.

In some instances, governor bars 22 may be altogether excluded from the chip diffuser 10. For example, governor bars 22 are unnecessary for controlling rotational speed where the free-falling particulate material has a slow velocity.

As mentioned previously, the helical positioning of the vane mounting rods 13 on the spider hub 14 influences rotational speed. Rotational speed can also be affected by vane pitch, as well as by toe-bar angles relative to vane pitch. Moreover, rotational speed can be affected by changing the relative sharpness (or bluntness) of the stream divider mechanism 27. Although these structural modifications affect rotor speed, the backside-mounted governor bars 22 are the preferred means for accomplishing such rotational speed control.

As noted previously, another technique for governing rotational speed includes adjusting the concentration of material flow upon the chip diffuser 10 (i.e., adjusting the “impact zone”). This is sometimes nearly as effective as employing governor bars 22 on the backside (i.e., bottom surface 21b) of the vanes 21. Preferably, both kinds of governing means (i.e., governor bar inclusion and impact zone adjustment) are used to adjust rotational speed.) Note, too, that where a fixed feed chute 20 is employed, impact zone adjustment can be facilitated by including thereunder a means to adjust the lateral position of the chip diffuser 10 (e.g., a lateral slide bar) and, optionally, a means to adjust the vertical position of the chip diffuser 10 (e.g., a vertical slide bar).

In another embodiment, each vane 21 can include at least one power bar 24, which is a raised strip running lengthwise (i.e., up-and-down), preferably slightly outwardly, on the top surface 21a of the vane 21. Although one power bar 24 is usually adequate (see FIGS. 2 and 3), in other embodiments, each vane 21 includes at least two power bars 24, which effectively separate the top surface 21a of the vane 21 into at least three sections. The power bars 24 promote even chip distribution over the entire distribution area. Inwardly directing the power bars 24 tends to reduce rotational speed, but such governing action is much less effective as that provided by governor bars 22.

It should be noted that when a large area is being diffused with wood chips, there is a tendency for the distributed wood chips to form a crater in the center of the built-up pile. By arranging the power bars 24 on some of the vanes 21 to direct wood chips inwardly, this crater effect is eliminated and the resulting chip pile is essentially flat-topped.

Accordingly, in a preferred embodiment, there are six vanes 21 having alternating power bar arrangements. For example, in one embodiment as shown in FIG. 2, the power bars 24 connected to the first, third, and fifth vanes 21 are outwardly directed. Moreover, as shown by phantom lines, the power bars 24a connected to the second, fourth, and sixth vanes 21 may be inwardly directed to the center of the pattern-area.

In another embodiment, the chip diffuser 10 includes a toe bar 25 to promote even chip distribution over the entire distribution pattern. The toe bar 25 is an angled component formed at the lower edge of the vane 21 (i.e., the edge of the toe bar 25 is connected to the lower edge of the vane 21). Stated otherwise, the vane 21 is offset from the axis defined by the central shaft stem 12, and the corresponding toe bar 25 is further offset from this axis. The toe bar 25 can extend fully or partially across the lower width of the vane 21.

A toe bar 25, as herein described, is a discrete component from its corresponding and contiguous vane 21. Accordingly, those of ordinary skill in the art will appreciate that there is no inconsistency in describing a chip diffuser 10 having a substantially planar vane 21 and a toe bar 25.

In its simplest embodiment shown in FIGS. 1-6, the toe bar 25 includes a substantially rectangular piece that is angled away from the direction of the rotor assembly's 11 rotation up to about 30°, and preferably between about 15° and 30°, from the top surface 21a of its corresponding vane 21.

In a related embodiment, the toe bar 25 is a compound design formed from a plurality of angled pieces that are connected edge to edge such that a first substantially rectangular piece is angled from a vane 21 and a second substantially rectangular piece is further angled from the first substantially rectangular piece. For example, the first substantially rectangular piece can be offset about 30° from the top surface 21a of its corresponding vane 21, and the second substantially rectangular piece can be offset about another 30° from the first substantially rectangular piece (i.e., the total toe bar angle from the top surface 21a of vane 21 is about 60°).

In yet another embodiment shown in FIGS. 7-8, the toe bar 25′ preferably includes a curved section 33, especially at the interface between the vane 21′ and the toe bar 25′. In this embodiment, the toe bar 25′ can appear as a gradual continuation of its corresponding vane 21′. This kind of curved toe bar design has been employed with up to about a 90° offset (i.e., turn or angle) from the top surface 21a′ of the corresponding vanes 21′, and has been observed to be useful for loading larger spaces (e.g., ships).

Testing has shown that the total offset between the toe bar 25 and top surface 21a of its corresponding vane 21 is preferably between about 15° and 90°. In this regard, it has been observed that as the upward angle of the toe bars 25 relative to their corresponding vanes 21 increases, distribution distances of the particulate material likewise increase.

In a preferred embodiment, there are six vanes 21 having alternating toe bar arrangements (i.e., the toe bars 25 connected to the first, third, and fifth vanes 21 are the same, and the toe bars 25 connected to second, fourth, and sixth vanes 21 are the same).

In yet another embodiment, fingers are attached to the lower edge of one or more of the vanes 21 or toe bars 25. As the chip diffuser 10 rotates, these fingers sweep and clear any strings and slivers that have accumulated on first support arm 17 and strut 18. The fingers are preferably made from hardened metal, such as round iron rod.

In yet another embodiment, as shown in FIGS. 1-3 and 7, a vane plate 26 shown can be attached either to the central shaft stem 12 or to upper edges of the plurality of vanes 21 such that the vane plate 26 is positioned between the central shaft stem 12 and the feed chute 20. When attached to the upper edges of the plurality of vanes 21, the vane plate 26 provides further support for the vanes 21 (i.e., another point of contact in addition to that provided by the vane mounting rods 13), thereby maintaining the vanes 21 at an equal angle from the central shaft stem 12. The vane plate 26 also prevents material from falling into the center of the chip diffuser 10, which can cause the vanes 21 to move from their fixed positions.

Mounted on top of the vane plate 26 can be a stream divider mechanism 27 (i.e., a “witch's hat”) that separates the flow of falling chips toward the respective vanes 21. Alternatively, the stream divider 27 and vane plate 26 may be directly mounted to the central shaft stem 12, or, if a vane plate 26 is not employed, the stream divider 27 may be directly mounted to the central shaft stem 12. The stream divider mechanism 27 is preferably pyramidal, most preferably tetrahedral, or conical.

The stream divider mechanism 27 should be centered over the central shaft stem 12 and spider hub 14 to prevent plugging the spider helix rotor assembly 11. The stream divider mechanism 27 preferably has a steep slope that is greater than about 20° from vertical (i.e., between 0° and about 20° from vertical). An exemplary stream divider mechanism 27 is six-inches high with a two-inch base.

In chip diffuser embodiments in which the rotor assembly 11 is positioned beneath (i.e., hung from) the central shaft stem 12, the stream divider mechanism 27 includes a central opening to accommodate the central shaft stem 12. In this embodiment, it is preferred to include a shielding means to eliminate material falling between the stream divider 27 and central shaft stem 12.)

As described previously, particulate material is fed onto the spider helix rotor assembly 11 and attached vanes 21, typically through a feed chute 20. Preferably, the particulate material comprises wood chips that are fed to and distributed by the chip diffuser 10 at a rate of at least about five tons per minute.

The forces applied to the vanes 21 by the falling particulate material cause the chip diffuser 10 to rotate around its central shaft stem 12, which significantly improves the distribution of the particulate material (i.e., promotes uniform material distribution over the distribution area). In particular, the energy necessary to rotate the rotor assembly 11 and the attached vanes 21 is provided only from the kinetic energy of particulate material contacting the chip diffuser 10. It has been observed that focusing the particulate material off the center of the rotor assembly 11 and the attached vanes 21 tends to increase the chip diffuser's 10 rotational speed.

Those having ordinary skill in the mechanical arts know that vibrations can damage mechanical devices. Accordingly, it is believed that damping natural-frequency mechanical vibrations will extend the useful life of the chip diffuser 10. Damping means are within the understanding of those having ordinary skill in the art. For example, it has been observed that strategically positioning one or more angle-iron members to the backside of each vane 21 effectively eliminates natural-frequency vibrations.

Employing the chip diffuser 10 has been found to increase the compaction of distributed wood chips by at least about five percent (e.g., about seven percent or more). To maximize the benefits of the chip diffuser 10, however, wood chips must be layered into the storage space so that the wood chips do not cascade as they accumulate into a chip pile (i.e., cascading compromises compaction efficiency). Layering wood chips is facilitated by moving the chip diffuser 10 about a storage space. This not only reduces cascading, but also increases the compaction of the distributed wood chips by at least about 15 percent (e.g., between about 17 and 30 percent) as compared to undiffused wood chip transfers. It has been observed that while the chip diffuser 10 is beneficial for most particulate material, it provides better densification for relatively longer wood chips (e.g., about one inch long) than for relatively shorter wood chips (e.g., about ⅝ inch long).

The compaction efficiency of the chip diffuser 10 according to the present invention is illustrated by FIG. 9, which is a photograph of a pile of wood chips that have been partially removed by a bulldozer. The ordered stacking of the wood chips resulting from the chip diffuser's 10 use creates a sheer wall of uniformly stacked chips and is analogous to the higher densities achieved by potato chips that are uniformly stacked in a cylinder rather than loosely packaged in a bag. As noted previously, this kind of regular wood chip orientation increases storage density by as much as 30 percent over conventional wood chip piles.

In the specification and the drawings, typical embodiments of the invention have been disclosed. Specific terms have been used only in a generic and descriptive sense, and not for purposes of limitation. The scope of the invention is set forth in the following claims.

That which is claimed is:

1. A chip diffuser that is useful in efficiently distributing particulate material, comprising:
a central shaft stem;
a spider helix rotor assembly that comprises a spider hub that is rotatably mounted onto said central shaft stem and at least two vane mounting rods that are non-radially attached to said spider hub; and
substantially planar vanes that are attached at an angled pitch to said vane mounting rods, said vanes having a top surface and a bottom surface.

2. A chip diffuser according to claim 1, wherein said spider helix rotor assembly is rotatably mounted atop said central shaft stem.

3. A chip diffuser according to claim 1, wherein said spider helix rotor assembly is rotatably mounted along said central shaft stem.

4. A chip diffuser according to claim 1, wherein said spider helix rotor assembly is rotatably mounted beneath said central shaft stem.

5. A chip diffuser according to claim 1, wherein said spider helix rotor assembly is substantially planar.

6. A chip diffuser according to claim 1, wherein said vane mounting rods are near-tangentially attached to said spider hub.

7. A chip diffuser according to claim 1, wherein said spider helix rotor assembly comprises between about four and eight vane mounting rods that are uniformly spaced around said spider hub.

8. A chip diffuser according to claim 1, wherein said spider helix rotor assembly comprises six vane mounting rods that are uniformly spaced around said spider hub.

9. A chip diffuser according to claim 1, wherein said spider helix rotor assembly has a leading arrangement whereby said vane mounting rods are oriented toward the direction of rotation.

10. A chip diffuser according to claim 9, wherein said spider helix rotor assembly is configured such that its vane mounting rods are non-radially oriented between about 50° and 80° from tangents intersecting contact points defined by said vane mounting rods and said spider hub.

11. A chip diffuser according to claim 1, wherein said spider helix rotor assembly has a lagging arrangement whereby said vane mounting rods are oriented away from the direction of rotation.

12. A chip diffuser according to claim 1, wherein said spider helix rotor assembly is collapsible.

13. A chip diffuser according to claim 1, wherein said vanes are attached to said vane mounting rods in a one-to-one relationship.

14. A chip diffuser according to claim 1, wherein said vanes are substantially rectangular.

15. A chip diffuser according to claim 1, wherein said vanes are attached to said vane mounting rods at a pitch of between about 10° and 40°.

16. A chip diffuser according to claim 1, wherein said vanes are attached to said vane mounting rods at a pitch of between about 20° and 30°.

17. A chip diffuser according to claim 1, wherein said vanes are attached to said vane mounting rods at a pitch of between about 22° and 25°.

18. A chip diffuser according to claim 1, wherein said vanes are collapsible.

19. A chip diffuser according to claim 1, further comprising means to support the chip diffuser during operation, said support means connected to a non-rotating component of said chip diffuser.

20. A chip diffuser according to claim 19, wherein said support means is connected to said central shaft stem.

21. A chip diffuser according to claim 1, further comprising at least one J-shaped support to secure the chip diffuser from beneath, each said J-shaped support incorporating said central shaft stem.

22. A chip diffuser according to claim 21, further comprising a feed chute that is connected to said at least one J-shaped support and that is positioned above said spider helix rotor assembly to facilitate the delivery of particulate material to said chip diffuser.

23. A chip diffuser according to claim 1, further comprising governing means to limit the chip diffuser's rotational speed during operation.

24. A chip diffuser according to claim 23, wherein said governing means comprises a governor bar on the backside of at least one said vane.

25. A chip diffuser according to claim 24, further comprising a collector bar connected to said governor bar.

26. A chip diffuser according to claim 23, wherein said governing means comprises a governor bar on the backside of each said vane.

27. A chip diffuser according to claim 23, wherein:
said governing means comprises a governor bar on the backside of a first said vane; and
said governor bar and a second said vane are configured in a trough-forming geometry.

28. A chip diffuser according to claim 1, further comprising a collector bar connected to at least one said vane.

29. A chip diffuser according to claim 1, further comprising at least one power bar on the top surface of at least one said vane.

30. A chip diffuser according to claim 1, further comprising at least one power bar on the top surface of each said vane.

31. A chip diffuser according to claim 1, further comprising a toe bar connected to the lower edge of at least one said vane.

32. A chip diffuser according to claim 1, further comprising a toe bar connected to the lower edge of each said vane.

33. A chip diffuser according to claim 32, wherein each said toe bar is angled up to about 30° from the top surface of its corresponding vane.

34. A chip diffuser according to claim 32, wherein each said toe bar is angled up to about 90° from the top surface of its corresponding vane.

35. A chip diffuser according to claim 34, wherein each said toe bar comprises a curved section.

36. A chip diffuser according to claim 1, further comprising a vane plate that is attached either to said central shaft stem or to the upper edges of a plurality of said vanes.

37. A chip diffuser according to claim 1, further comprising a stream divider mechanism positioned over said central shaft stem.

38. A chip diffuser according to claim 1, wherein said chip diffuser is capable of functioning using only the kinetic energy of particulate material contacting said chip diffuser.

39. A chip diffuser according to claim 1, wherein the chip diffuser is capable of distributing at least about five tons of wood chips per minute.

40. A chip diffuser according to claim 1, wherein the chip diffuser is capable of distributing at least about 15 tons of wood chips per minute.

41. A chip diffuser according to claim 1, wherein the chip diffuser is capable of distributing at least about 30 tons of wood chips per minute.

42. A method of using the chip diffuser according to claim 1, comprising feeding particulate material onto said spider helix rotor assembly and said attached vanes of said chip diffuser, thereby effecting the rotation of said spider helix rotor assembly and said attached vanes around said central shaft stem and the outward redirection of particulate material.

43. A method of using the chip diffuser according to claim 42, further comprising positioning said chip diffuser under a feed chute prior to the step of feeding particulate material onto said chip diffuser.

44. A method of using the chip diffuser according to claim 42, further comprising moving said chip diffuser about a space to distribute the particulate material within the space.

45. A method of using the chip diffuser according to claim 42, wherein the step of feeding particulate material onto said chip diffuser comprises feeding wood chips onto said chip diffuser.

46. A method of using the chip diffuser according to claim 42, wherein the step of feeding particulate material onto said spider helix rotor assembly and said attached vanes of said chip diffuser comprises feeding at least about five tons of wood chips per minute onto said spider helix rotor assembly and said attached vanes of said chip diffuser.

47. A chip diffuser that is useful in efficiently distributing wood chips and other particulate materials, comprising:
a central shaft stem;
a substantially planar spider helix rotor assembly that comprises a spider hub that is rotatably mounted onto said central shaft stem and between four and eight vane mounting rods that are uniformly and non-radially attached to said spider hub; and
vanes that are attached in a one-to-one relationship to said vane mounting rods at a pitch of between about 10° and 40°, said vanes having a top surface and a bottom surface.

48. A chip diffuser according to claim 47, wherein said spider helix rotor assembly is in a leading arrangement wherein its vane mounting rods are non-radially oriented between about 50° and 80° from the respective tangents intersecting contact points defined by said vane mounting rods and said spider hub.

49. A chip diffuser according to claim 47, wherein said vanes are attached to said vane mounting rods at a pitch of between about 20° and 30°.

50. A chip diffuser according to claim 47, further comprising governing means to limit the rotational speed of the chip diffuser during operation.

51. A chip diffuser according to claim 47, further comprising at least one power bar on the top surface of at least one said vane.

52. A chip diffuser according to claim 47, further comprising a toe bar connected to the lower edge of each said vane.

53. A chip diffuser according to claim 52, wherein each said toe bar is angled up between about 15° and 90° from the top surface of its corresponding vane.

54. A chip diffuser according to claim 47, further comprising a collector bar connected to each said vane.

55. A chip diffuser according to claim 47, further comprising a stream divider mechanism positioned over said central shaft stem.

56. A chip diffuser according to claim 47, wherein said spider helix rotor assembly includes exactly six vane mounting rods and said vanes include exactly six vanes.

57. A chip diffuser according to claim 56, wherein:
the first, third, and fifth vanes each comprise at least one power bar that is inwardly directed; and
the second, fourth, and sixth vanes each comprise at least one power bar that is outwardly directed.

58. A chip diffuser according to claim 56, wherein said vanes include toe bars in an alternating toe bar arrangement.

59. A chip diffuser according to claim 47, wherein said chip diffuser is capable of efficiently distributing particulate material by rotating around its said central shaft stem using only the kinetic energy of the particulate material contacting said chip diffuser.

60. A chip diffuser according to claim 47, wherein the chip diffuser is capable of distributing at least about five tons of wood chips per minute.

61. An improved method of efficiently distributing particulate material, comprising:
providing a chip diffuser that comprises a central shaft stem, a rotor assembly that is rotatably mounted onto the central shaft stem and that has at least two vane mounting rods, and vanes that are attached at an angled pitch to the vane mounting rods; and
feeding particulate material onto the chip diffuser, thereby effecting the rotation of the rotor assembly and the attached vanes around the central shaft stem and the outward redirection of the particulate material;
wherein the energy necessary to rotate the rotor assembly and the attached vanes is provided by only the kinetic energy of particulate material contacting the chip diffuser.

62. An improved method of distributing particulate material according to claim 61, wherein the rotor assembly is a spider helix rotor assembly characterized by vane mounting rods that are non-radially attached to a spider hub.

63. An improved method of distributing particulate material according to claim 61, wherein the step of feeding particulate material onto the chip diffuser comprises transferring particulate material through a feed chute onto the rotor assembly and the attached vanes.

64. An improved method of distributing particulate material according to claim 63, wherein the step of transferring particulate material through a feed chute onto the rotor assembly and the attached vanes comprises transferring particulate material through an substantially vertical feed chute onto the rotor assembly and the attached vanes.

65. An improved method of distributing particulate material according to claim 63, wherein the step of transferring particulate material through a feed chute onto the rotor assembly and the attached vanes comprises transferring particulate material through a non-vertical feed chute onto the rotor assembly and the attached vanes.

66. An improved method of distributing particulate material according to claim 63, wherein the step of transferring particulate material through a feed chute onto the rotor assembly and the attached vanes comprises focusing the transfer of particulate material off the center of the rotor assembly and the attached vanes.

67. An improved method of distributing particulate material according to claim 61, further comprising moving the chip diffuser about a storage space to further distribute particulate material within the storage space.

68. An improved method of distributing particulate material according to claim 61, wherein the step of feeding particulate material onto the chip diffuser comprises feeding wood chips onto the chip diffuser to thereby increase the compaction of the distributed wood chips by at least about five percent.

69. An improved method of distributing particulate material according to claim 61:
wherein the step of feeding particulate material onto the chip diffuser comprises feeding wood chips onto the chip diffuser; and
further comprising moving the chip diffuser about a storage space to further distribute wood chips within the storage space to thereby increase the compaction of the distributed wood chips by at least about 15 percent.

70. An improved method of distributing particulate material according to claim 61, wherein the step of feeding particulate material onto the chip diffuser comprises feeding wood chips onto the chip diffuser at a rate of at least about five tons per minute.

71. An improved method of distributing particulate material according to claim 61, wherein the step of feeding particulate material onto the chip diffuser comprises feeding wood chips onto the chip diffuser at a rate of at least about 15 tons per minute.

72. An improved method of distributing particulate material according to claim 61, wherein the step of feeding particulate material onto the chip diffuser comprises feeding wood chips onto the chip diffuser at a rate of at least about 30 tons per minute.

73. An improved method of efficiently distributing wood chips, comprising:
providing a chip diffuser that comprises a central shaft stem, a spider helix rotor assembly that comprises a spider hub that is rotatably mounted onto the central shaft stem and at least two vane mounting rods that are non-radially attached to the spider hub, and an least one substantially planar vane that is attached at an angled pitch to each vane mounting rod, wherein at least one vane includes a toe bar formed at its lower edge; and
feeding wood chips onto the chip diffuser, thereby effecting the rotation of the rotor assembly and the attached vanes around the central shaft stem and the outward redirection of the wood chips;
wherein the energy necessary to rotate the rotor assembly and the attached vanes is provided by only the kinetic energy of wood chips contacting the chip diffuser.

74. An improved method of distributing wood chips according to claim 73, wherein the step of is feeding wood chips onto the chip diffuser comprises feeding wood chips at a rate of at least about five tons per minute.

75. An improved method of distributing wood chips according to claim 73, further comprising moving the chip diffuser about a space to further distribute wood chips within the space to thereby increase the compaction of the distributed wood chips by at least about 15 percent.
